(19) United States
(12) Patent Application Publication
(10) Pub. No.: US 2025/0209139 A1
(43) Pub. Date: Jun. 26, 2025

(54) LICENSE BINDING OF AN APPLICATION LICENSE TO A DEVICE

(71) Applicant: WIBU-SYSTEMS AG, Karlsruhe (DE)

(72) Inventors: Wolfgang NEIFER, Karlsruhe (DE); Oliver WINZENRIED, Karlsruhe (DE); Peer WICHMANN, Bruchsal (DE)

(73) Assignee: WIBU-SYSTEMS AG, Karlsruhe (DE)

(21) Appl. No.: 18/847,602

(22) PCT Filed: Mar. 14, 2023
(86) PCT No.: PCT/EP2023/056493

§ 371 Date: Sep. 16, 2024

(30) Foreign Application Priority Data
Mar. 15, 2022 (EP) 22162268.1

(51) Int. Cl. G06F 21/10

(52) U.S. Cl. CPC G06F 21/1011; G06F 21/107

(57) ABSTRACT

A license agent apparatus for handling a license of an application of a licensor, including a device interface to communicate with a device having specific data; and a processing unit to generate a license container configured to maintain a license for the application. Also, a device having specific data characterizing the device and being configured to be bound to a license container, which is suitable to contain at least a license for an application, and being configured to communicate with a license agent or a license agent apparatus to provide the specific data for identifying the device and for creating device unique identity data, D-UID. Further, a corresponding system, a license container as well as corresponding methods.

The present invention relates to a license agent apparatus for handling a license of an application of a licensor, wherein the license is bound to a device, to a device having specific data uniquely identifying the device, and to a system for handling a license of an application of a licensor and for allowing the application to be executed using the license, wherein the license is bound to a device. The invention relates further to the respective methods to handle the license bound to the device. The invention relates further to a license container and to an extension container.

In the state of the art many applications, software or digital contents are known which allows a restricted usage only if a valid license is present. The type of licenses varies in multiple ways depending of the grade of safety or security which is requested. There are machineries known in the art which allows the execution of the machine only if a user has a respective license. For example, knitting machines are known that allow to produce a protected design only for a predetermined amount, e.g. for a restricted length of fabric panels of a certain pattern. It is also known that a specific pattern is only produced during a predetermined time period, e.g. for a couple of days or a restricted amount of production hours. These restrictions are handled using restricted licenses that are necessary to use a machine or content or to execute a certain application.

One typical license requires a license key in form of an alphanumeric string or a number which has to be entered in an application program during installation on a computer or on the first start or usage of the application or digital content.

Applications or machines that require a higher level of protection require licenses or license keys stored in a read-only memory stick with a cryptographic controller that allows access only to the licensed application or machine. These devices or dongles are complex, elaborate, and/or expensive.

Other licensing methods require a removable memory stick with a license signed by a certification authority. The licenses are tied to and limited to one licensor. These methods do not allow multiple licenses from different licensors. An example for such method can be found in EP 3 798 872 A1.

Another type of protection is fulfilled if the license is tied to a specific computer or a computer system with various components. The license is then tied to the components. If a component of the system is changed or exchanged, the license becomes invalid. Moreover, the license cannot be used with another system or computer, making the licensing method in special circumstances inconvenient, inflexible and rigid in practice. Such method is described in EP 2 515 499 B1.

The abbreviations and terms used in the text are explained below and will be used in the context described.

It is an object of the present invention to provide a more flexible but reliable method for licensing the use of an application, system or machinery or the like. The licensing scheme should provide a high level of security on the other side.

The object is achieved by a license agent apparatus having the features of claim 1, by a device having the features of claim 10, by a licensor device having the features of claim 16, by a system according to claim 17, and by a license container according to claim 19. The object is also achieved by a method according to claim 21 for creating an empty license container, by a method according to claim 26 for handling a license container containing a license, by a method according to claim 27 for filling an empty license container bound to a device with license relevant data, and a method according to claim 28 for using a license contained in an encrypted license container for an application.

In a first aspect of the present invention a license agent apparatus for handling a license of an application of a licensor is presented that comprises a device interface to communicate with a device having specific data and further comprises a processing unit to generate a license container configured to maintain a license for the application. The device may optionally have a storage medium for storing data.

The processing unit is configured to determine specific data of the device connected via the device interface, to generate, preferably randomly, a globally unique identifier, so-called device unique identity data (D-UID), based on the specific data of the device, and random data, and, optionally but preferred, to utilize an L-UID as unique identity data of the licensor of the application to be licensed. The L-UID may be provided by the licensor of the application.

Further the processing unit of the license agent apparatus is configured to create a license container containing at least the D-UID, the L-UID and a link value based on the application to be licensed (ABL), to encrypt the license container using a licensor public key (pub-L-key), and to provide the encrypted license container.

The license agent apparatus can be implemented as part of a computer or machine or machinery. The license agent apparatus can use components or elements with other machines or the like, e.g. a processor or processing unit. The license agent apparatus can also be implemented in software or as a program or an application.

In a further aspect of the present invention a device having specific data characterizing the device and being configured to be bound to a license container, which is suitable to contain at least a license for an application, is presented. The device is configured to communicate with a license agent or a license agent apparatus to provide the specific data for identifying the device and for creating device unique identity data (D-UID).

In another aspect of the present invention, the licensor device comprises a processor unit being configured to receive a license container and for decrypting the license container using the private licensor key priv-L-key, for filling the license container with at least one of the data of the group comprising at least a D-UID, a link value based on the application to be licensed (ABL), a license parameter, and license keys of the application, and for encrypting the filled license container with the public device key. Alternatively, a new license container can be created by the licensor with the same content as the filled container.

In a further aspect of the present invention a system for handling a license of an application of a licensor and for allowing the application to be executed using the license is presented. The system comprises a device having specific data characterizing the device and being configured to be bound to a license container, which is suitable to contain at least a license for an application, and being configured to provide the specific data for identifying the device. The system further comprises a license agent or a license agent apparatus for handling a license container containing a license to execute the application, to communicate with the device to read out the device-specific data. The license in the license container is bound to the device based on the device-specific data so that the application can only be executed if the license is valid and the device is present.

In a further aspect of the invention a license container and an extension container are presented. The license container contains at least one of the data of the group comprising at least a D-UID, a D-UID-cert, a link value based on the application to be licensed, license parameter, license specifications, and a license, apps-keys and/or a license key for executing the application, wherein the license container is preferably encrypted with the public licensor key and/or with the pub-D-key, and particularly preferably signed with the priv-L-key (private licensor key) and/or the priv-D-key, further preferably being read-only for a license agent apparatus being in possession of the priv-D-key. The license container is preferably stored in the device or alternatively at another, preferably secured or protected location, e.g., a storage memory. For the license agent apparatus, the license container is read-only and cannot be changed because the container is signed by the licensor with his priv-L-key. Otherwise, the signature of the licensor would be corrupted and the license in the container would become invalid.

The extension container is linked to the license container mentioned above and is configured to be accessible using the priv-D-key. The extension container comprises a current value of a counter which is preferably stored in the device. The extension container is preferably not stored in the device. The extension container can be changed and manipulated by the license agent apparatus because this container is signed by the priv-D-key.

In yet further aspects of the present invention, there are provided corresponding methods, a computer program which comprises program code means for causing a computer to perform the steps of the methods disclosed herein when said computer program is carried out on a computer as well as a non-transitory computer-readable recording medium that stores therein a computer program product, which, when executed by a processor, causes the methods disclosed herein to be performed.

Preferred embodiments of the invention are defined in the dependent claims. It shall be understood that the claimed method, system, computer program and medium have similar and/or identical preferred embodiments as the claimed system, in particular as defined in the dependent claims and as disclosed herein.

The present invention is based on the idea that a license for an application or a computer program or any other digital content is bound to a device which can be uniquely identified. The type of the binding can be defined by the licensor or rights holder of an application which is protected or secured by a license. The binding method should bind a license to a specific set of one or more attributes of a device which can be defined by the licensor. Additional flexibility is provided by this idea and technique which supports more flexible binding to a set of attributes which can be weighted and in which case only a subset of the defined attributes is required. The importance of the binding may depend on the attributes' weights, which may preferably tolerate small changes in the hardware setup, namely in the device. This may be important if one of the features is a bad-sector identification or a bad-sector number of the device.

As an alternative to the binding to attributes or specific data of a device, a customized binding method can also be implemented by the licensor according to the inventive idea. In this case, preferably a license can be updated to authorize or revoke authorization of specific functions or features of an application or content or change the conditions for authorization. This can be useful if a license is limited to a special number of executions or limited to an expiration date.

The inventive approach binds the license to a device which can for example be a storage media device having storage media. This device can preferably be removable or detachable from a machine or a computer or another electronic apparatus. The inventive approach allows for multiple devices of independent licensors to be bound to a license wherein individual types of bindings can be realized and provided. The types of bindings may depend on the applications to be secured by the license or depend on the licensor.

In addition and preferably, security and reliability can optionally be further improved if the device has a storage medium and in addition a protected memory area. This protected memory area can, for instance, be a cryptographic processor or controller. A license included or contained in a license container can be stored in a publicly available storage area of the device and the license can additionally be connected to securely stored data in the protected memory area. These can, for example, be a generation counter or another, preferable non-resettable and monotonic counter, which indicates, for example, the number of updates or the versions of the license data. The counter can also count the number of uses of an application or a content to which the license is linked.

According to the inventive approach, a license agent apparatus or license agent has the ability to create an empty license container which is bound to a device. The device is in communication with the license agent, preferably via a specific communication protocol, for example via a generic API. The license agent or a processor unit of the license agent is configured to determine specific data of the device and to randomly generate device unique identification data (D-UID), which are based on the specific data of the device and represent a globally unique identifier. This identifier may be an alphanumeric string or a random number. The license agent determines a private device key connected or corresponding to the device based on the specific data, random data and optionally based on the unique ID of the licensor, L-UID. The created private device key (priv-D-key) is not stored in any location or at any time of the processing. Only the random number (D-RND) and, if applicable, the L-UID are stored for later use. These data are preferably stored on the device if the device has a memory. The license agent creates an empty license container without any license. The license container contains at least the generated device unique identification data (D-UID), the identity data of the licensor (L-UID) and a link value, which is based on the application to be licensed. This empty license container is encrypted with the licensor public key pub-L-key, which is the public key of the encryption pair of the licensor. This public key is publicly available. Further, the public device key pub-D-key, which is the public key of the encryption pair of the device, is created by the license agent using the private device key priv-D-key. The public device key is preferably also stored in the license container so that it will be available for the licensor and can be used by the licensor later to encrypt the filled license container containing the license key. The license agent will then be in the position to decrypt the license container using his private device key priv-D-key.

The encrypted empty license container is provided by the license agent. The empty license container has to be brought to the licensor in any possible way. It can be transferred to the licensor by transmitting the empty license container via the Internet, a wired or wireless connection or any other transportation media.

If the public device key is not contained in the empty license container, it has to be made public by the license agent so that the licensor can use it for encrypting the license container at a later stage.

There are only a few requirements for the device to which the licensor or the license container is bound. The device has to be uniquely identified so that a reliable and secure binding between the license container containing the license and the device can be established. So, as a device any arbitrary device can be used. Examples for suitable devices are memory cards or memory sticks, any available and detachable memory media, SD-cards, internal hard disks or SSD, mobile phones, smart card reader or any other device. For example, it is possible that a software creating scans and using a specific scanner is protected by a license. In this case, the scanner can be the device to which the license is bound. The scanner also has to be uniquely identifiable. In such a case, it is possible that the application can only be executed if a valid license is present and a special type of scanner or one particular scanner is connected to the application or system running the application, respectively, and used by the application. Any other scanner would not work with the application even if the license were present since the license is bound to one particular scanner.

One advantage of the invention is that a specific communication protocol can be used for the communication between the license agent (LA) and the device. The communication protocol makes it possible to address different devices and types of devices via a common mechanism.

In a preferred embodiment of the license agent apparatus the processing unit is further configured to identify the device connected to the device interface. The device can be an internal device or, preferably, a detachable device which is connected to the license agent apparatus via a communication interface. This interface is preferably the device interface. The license agent apparatus is further configured to load a communication protocol corresponding to the identified device and it is configured to use the communication protocol for communication and for data exchange with the device. Preferably, a generic API is used. The preferred license agent apparatus allows for a different or any arbitrary device to be in connection with the license agent apparatus so that a communication with the device is possible. The types of devices are manifold so that a huge variety of different devices can be used working together with the license agent apparatus. The license and the license container, therefore, can nearly be bound to any device which has unique characteristics so that the device can be uniquely identified.

In a preferred embodiment of the license agent apparatus the processing unit is further configured to determine a private device key (priv-D-key) of the device based on the specific data of the device, based on a D-RND random number, and optionally based on the L-UID. The processing unit is further configured to create the public device key (pub-D-key) based on the private device key (priv-D-key). The processing unit may also be configured to store the L-UID and/or optionally the D-RND for later use; these data may be necessary to recreate or regenerate the private device key which is not stored at any location. The L-UID and the D-RND are stored at an arbitrary medium, optionally preferably on the device itself, if the device has a storage medium.

In a further preferred embodiment of the license agent apparatus the processing unit is configured to assign the license container with the private key of the device, priv-D-key. So, any other apparatus or system such as a computer or a machine, which is in possession of the publicly available public key of the device, pub-D-key, can unambiguously and explicitly verify that the license container belongs to the respective device and that the content of the license container is unchanged.

Further, according to a preferred embodiment, the processing unit is configured to store the pub-D-key in the license container before encrypting the license container using the public key of the licensor, pub-L-key. This has the advantage that the licensor, after decrypting the license container with his private key has direct access to the public key of the device, pub-D-key, so that he is able to later encrypt the license container with the public device key, pub-D-key.

So, only the license agent apparatus, which has access to the private key of the device can restore or retrieve the license key from the container.

In a further preferred embodiment, the processing unit of the license agent apparatus is configured to create a self-signed D-UID-certificate. The certificate is created using the private device key, priv-D-key, the pub-D-key, and the D-UID so that the unique identification data of the device, D-UID, are linked to the public key of the device. The certificate is signed by the private device key. The processing unit is further configured to store this D-UID-certificate created in the license container. The storage takes place before the encryption of the license container.

Since the license container has no license included, it is called “empty” license container because the license is missing.

It is further preferred that the processing unit is configured to retrieve the device-specific data which have been used for creating the private device key, priv-D-key from the device, which is connected via the device interface. Further, the processing unit retrieves the D-RND random number, which is preferably stored in the device and the L-UID, which is preferably also stored in the device. The processing unit is further configured to restore or recreate the priv-D-key if needed so that the license agent apparatus can decrypt the license container to use the contained information, preferably the contained license or license key. This is necessary if an application secured by a license requests the respective license to be executed.

In a further preferred embodiment, the processing unit is configured to receive a license container containing a license for the application. The license container is received from the licensor or the licensor's device. The processing unit is preferably further configured to store the license container on the device, which is connected to the license agent apparatus, preferably via the device interface. So, the license agent is in a position to provide the license stored in the license container on request.

In another preferred embodiment of the license agent apparatus, the processing unit is configured to allow the application to use the license contained in the license container after decrypting the license container. This is possible because the license agent is in the position to decrypt the license container received and to provide the contained license to the application.

In a further preferred embodiment, the processing unit of the license agent is configured to receive a license container containing a license for the respective application. The processing unit is further configured to verify the license container, preferably using the public licensor key, which is available to the license agent. Preferably, the verification of the license container includes a mathematical verification and/or a verification in terms of the content. This may include a check regarding expected values or types of data.

In a preferred embodiment of the system, the system for handling the license of an application and for allowing the application to be executed using the license comprises a storage medium on which the application is stored, a processor unit for executing the application, and an application interface for communicating between the license agent apparatus and the processor unit for executing the application requiring a license to be executed. The system also comprises a bidirectional interface to exchange at least the license container between the license agent apparatus and a licensor device, the licensor device being configured to store a license in a license container. The license in the license container is bound to the device so that the application can only be executed if the license is valid and the device is present. Preferably the license agent apparatus is configured to communicate with the application, and to communicate and exchange data with the device, and optionally and preferred to store data in the device, if possible, namely if the device comprises an optional storage medium. Further preferably the device may comprise a storage medium so that data and/or the license container can be stored in the device.

In a further preferred embodiment, the system may comprise a license agent apparatus as described above.

Regarding the device having specific data characterizing the device, in a preferred embodiment the device has a storage medium or a storage area, in which data can be stored. The device is preferably configured to store data and, further preferably, to store a license container. The specific data of the device preferably comprise at least one member selected from the group comprising at least serial number of the device, chip specification data, memory area specification data, bad sector information, type of device, production data, production badge of the device, safety information stored in the device. The specific data can be provided by the device via an interface or can be retrieved from a license agent via a communication interface.

In a preferred embodiment, the communication with the device takes place using a generic API. The communication preferably requires a direct connection of the detachable device with a device interface or a device connector of the license agent apparatus.

Preferably, the device comprises a storage area, which is protected, preferably by a password. This storage area may be a self-encrypting region of the device or maybe comprised in such a region. Also preferably, the device has a cryptographic controller having a storage capacity, preferably with accessible assigned and access protected address spaces. Further preferably, the license container and/or the D-RND and/or the L-UID are stored in said password-protected storage area or in the storage capacity of the cryptographic controller.

Further preferably, the cryptographic controller contains a monotonic counter, which is non-resettable. The cryptographic controller and/or the storage capacity of the controller and/or the password-protected storage area of the device can be used to implement a back-up approach for the license and/or the license container. A counter value of the optional counter or a copy of a license container can be stored in these areas.

In a preferred embodiment, the password-protected area or another restricted area such as a cryptographic controller, can be accessible only using the private device key, priv-D-key.

The invention has the advantage that the license can be bound to any arbitrary device, preferably to a device with a storage medium, further preferably a removable device. The license enables one or more functions of features under zero or more conditions, preferably on the device and storage medium. Said conditions can, for example, be a unit counter or an expiration time. The license or license container preferably uses cryptographic keys to protect or enable the functions and features. The license or license container can be bound to one or more attributes of the device, preferably of the removable device. Preferably, the attributes or their combination is unique.

Optionally, if the device includes a removable storage medium, which provides a protected memory region, it can be used by the license agent to save license or license container-dependent information such as an update counter or hashes in order to additionally and optionally protect the license from being reset or manipulated.

The inventive approach supports multiple licenses from multiple licensors being bound to the same device, preferably to the same storage device so that independent authorization usage of software and features from several rightsholders is possible. The licenses can be updated and revoked separately and independently. Authorization to use functions and features as well as the conditions for usage can be updated or revoked separately. The binding method can individually be defined for each license and/or for each licensor.

The advantage of the inventive approach is that it supports memory devices or devices of various producers. Optionally, proprietarily protected memory areas of various producers of the device can be supported.

A further advantage of the invention is that a high reliability can be achieved by optionally adding redundancy. A backup of the license can be stored on a storage area of a device, preferably in a restricted and protected storage area. The backup can be used to recover the license for example in case of an erroneous update.

The invention allows the license itself to be programmed and created, updated, or revoked on a device that is different from the device on which the functions or features are intended to be enabled.

Advantageously, the compatibility of the license with various platforms from various producers in various operating systems, hardware, CPU types, etc. can be easily and reliably supported. Optionally, the license on a storage medium or on a removable device can additionally be used as a secure storage for key material or certificates. Each stored key and certificate can be updated or removed separately.

Optionally, the key derivation method, which generates the secret key (private keys of the device) used by the license to authorize functions and features may use a “generation counter”, which is basically an update counter for the license, to make these licenses incompatible with other licenses or other versions of this license.

Further, also optionally, the license data can be stored redundantly on multiple storage media, for example on other removable storage devices and on the device or platform on which the protected functions and features are executed. The redundancy can be used as a backup for error handling as well as additional protection for the license against resetting or tampering. Instead of multiple storage media a storage area inside a cryptographic controller or in a protected storage region can be used.

Optionally and also preferably, the described approaches can be applied to non-removable devices or non-removable storage devices embedded into the apparatus, device or platform running the protected function and features and/or the protected application or software.

In the following some relevant definitions and additional explanations are given:

Generally, encryption with a private/public key pair is always encryption with the public key. This ensures that anyone (who knows the public key) could have performed the encryption and that only the owner of the private key can perform the decryption again.

Signing with a private/public key pair is always done with the private key. This ensures that anyone (who knows the public key) can verify the signature.

Encrypting with a symmetric key. Here, the symmetric key must be available for both encryption and decryption.

Keys and data in the invention and the respective system

### Licensor or Licensor Device:

In the context of this text, the term “licensor” shall be understood to mean a licensing device or licensing apparatus when it is not meant to mean the owner of an application secured by a license or the owner of a license or license key for an application, machine program, digital content or the like.

The abbreviations used have the following meaning:
Apps Application secured with a license so that the execution or use is restricted and only possible if a valid license is present. Apps or application also comprises an application, program, machinery or machinery program, digital content, software, or the like.
L-UID a unique identification of the licensor. This can be the name of the licensor in the simplest case.
L-UID-key a private/public key pair used to identify the licensor. The licensor key comprises the pub-L-key as public key and the priv-L-key as private key.
L-UID-cert a certificate used to bind the L-UID to the L-UID-key (pub-L-key); issued by the licensor or a central certification authority; used for communication of the license agent apparatus (or device, indirectly) with the Licensor
App-keys one or more symmetric and/or asymmetric keys required to operate the “App” application. This has the same meaning as license or license key used herein. The app keys or license keys are not included in the application, but are needed to run the application.
LA license agent apparatus, handling the license, a license request from the application, and the communication with the licensor; creating an empty license container; checking validity of the license container received from the licensor
Validation Data Data necessary for the validation of the L-UID-cert by the license agent apparatus
link value link value is based on the application to be licensed; may contain a request for a license or may contain data describing the application for which a license is requested or a type of license, a name of the license with or without name of the licensor, or the like.
Device: the device has to have at least specific data to uniquely identify the device. The data have to be configured to be read-out via a communication protocol by the license agent apparatus. The device may contain a storage memory so that data can be stored on the device. However, the device does not have to have a storage memory. In this case, the data to be preferably being configured to be stored in the device will be stored at another location, e.g. in the system or computer containing the license agent apparatus, in a different storage medium, like a hard disk, or the like. In preferred embodiments, the device may comprise, preferably in addition to a storage memory, a protected or access-restricted area for storing data or a cryptographic controller.
D-Comm Communication protocol for the specific device.
D-UID A globally unique identity data for identification of the device; based on specific data of the device and on a globally unique identifier which can be an alphanumeric string or a random number for example, wherein the specific data of the device can be read out via a communication protocol, e.g. the D-comm.
D-UID-key a private/public key pair used for identification purposes. The device key (D-UID-key) comprises the pub-D-key as public key and the priv-D-key as private key; D-UID-key is created and handled by the license agent, LA; the priv-D-key is preferably not stored at any location.
D-UID-cert A self-signed certificate that binds the D-UID to the (public) D-UID-key (pub-D-key). If necessary, the L-UID can also be stored in this certificate to ensure assignment to a specific licensor, if the license container is used for multiple different licensors. the certificate of the device is issued by the license agent apparatus and used by the licensor to check validity.
D-RND random data of the device, which are used for the determination of keys; D-RND will be stored in the device, if applicable.

### Storage/Determination of Data in Operation

For the data it is described below how and where they are generated. Here it is described where the data are stored in the control mode or how they are generated.

There are several options for stored data in connection with the Device:
Storage in a protected area, which is only accessible via a special API.
Storage in the public memory area of the device
Storage in the memory of the device to which the device is connected.

Depending on the use, the technical area of application, the security requirements and/or the business model, one or the other variant is possible or advantageous.

### The D-UID-Key

The private key of the device (priv-D-key) is a special case and is not stored. It is determined on demand. For this purpose, measured specific values of the device and stored random data are processed with the aid of a key derivation. The actual private key of the device (priv-D-key) is determined from this.

Device specific data (as described below), the data of the licensor (e.g. L-UID) and a random component or random number D-RND are used therefore. If necessary, the device specific data must be subjected to error correcting measures in order to catch changes in the data (e.g. Bad Sector Information).

Creation of an empty license container by the license agent apparatus:
1. The application creates the request for a license container vis-à-vis the LA. The request may contain a link value based on the application to be licensed. In addition to the optional type of license container, the L-UID-cert is also transferred. The L-UID-cert may be available via the internet or contained in the application.
2. the LA checks the validity of the L-UID-cert.
3. identifying of the device
4. loading the (optionally specific) communication protocol D-Comm with the device. This can be done as DLL or other specification of the protocol. The protocol specifications are either stored on the device, assigned in the LA or can be loaded from external resources.
5. determining the device specific data from the device which is in communication with the LA.
   These data can be for example:
   a. serial number
   b. CHIP-Identification
   c. Bad-Sector Information
   d. Special safety information stored in the device, if possible. Storing can be performed in a public area of a memory element of the device or in a restricted and/or protected area, if the device has a storage medium and/or a restricted and/or protected area or at an alternative location (protected or not), e.g. at an alternative storage medium being part of a computer or machinery.
6. generating the D-UID randomly, preferably possibly with deterministic components.
7. determining the private D-UID-key (priv-D-key) as described above from the device specific data, the unique data of the licensor (L-UID) and the random component D-RND. If necessary, the device specific data must be subjected to error-correcting measures in order to catch changes in the data (e.g. bad sector information).
8. storing the used random data D-RRN and the L-UID on the device, if the device preferably has a storage medium, or at an alternative location. This can be either in the publicly accessible area, or in a protected area that maybe addressed via a specific protocol only, in case of a protected area on a device via a device specific protocol only.
9. calculating the public D-UID-key (pub-D-key) from the private D-UID-key (priv-D-key).
10. creating the D-UID-cert as a self-signed certificate, signed with the private D-UID-key (priv-D-key)
11. storing the D-UID certificate in the device, (visible (publicly) or protected, see above.)
12. creating a so-called empty license container, which contains at least the following information, but no license or license key
   a. D-UID
   b. D-UID-cert
   c. L-UID
   d. Identification of the requested license by identification of the requesting program or specification of the requested license. This is preferably a link value based on the application or program to be licensed.
13. signing the empty license container with the D-UID-key and storing the container in the device.
14. encrypting the empty license container with the L-UID-key and sending it to the licensor so that the licensor can fill or create the container with a license or license key.

### Creation of a License Container at the Licensor

1. the licensor decrypts the empty license container
2. the Licensor checks the included D-UID-cert for mathematical and content-related
correctness
3. the Licensor creates a new license container or fills the “empty” license container, which can contain, among other data, the following:
   a. D-UID
   b. D-UID-cert
   c. license specification
   d. App-keys or license key for the application or any other kind of license
4. the license container is signed with the L-UID-key
5. the signed license container is encrypted with the D-UID-key (pub-D-key) and transferred to the license agent apparatus (LA) where the device is located and connected to so that the LA can communicate with the device (e.g. as described above).

Storing a license container into the device (if the device has a memory) or at an alternative location on a storage memory
1. the LA determines the private D-UID-key (priv-D-key) as above and decrypts the license container which is signed by the licensor or licensor device.
2. the LA checks the signature of the license container mathematically and in terms of content.
3. the signed license container is stored on the device (public or secured in the respective area of the device, if applicable, or at another).

### Executing of an Application Requiring a License

1. the application requests a valid license for execution from the LA.
2. the LA determines the private D-UID-key (as described above) and decrypts the license container containing the license.
3. the LA checks the signed license container mathematically and in terms of content. The license container is signed by the licensor with its priv-L-key.
4. the LA allows the use of the app keys or license or license key(s), respectively.
5. the application is executed and running using the app keys or license or license key(s), respectively.

### Non-Resettable and Monotonic Counters

Some devices have special non-resettable monotonic counters. Depending on the type, these can either only be decreased or only increased. For the use there are no essential differences for both variants, because the counters can be interpreted to get a corresponding direction. In the following it is therefore assumed that the counter can only be increased.

If the device, having a public and/or preferably a protected and access restricted storage, e.g. a cryptographic controller, has one or more non-resettable counters, further safety mechanisms are possible with it:
1. a counter can be used as generation counter for a license container. In this case, the current counter reading is transmitted to the licensor together with the empty container and is included by the licensor in the signed license container. This effectively prevents the license container from being used with an old license.
2. The counter can be included in the license container as a limit counter and restrict the number of application starts or the use of special functions. For this purpose, a note is made in the license container up to which counter value a start or the use of a function is permissible.

### Optional Cryptographic Controller in the Device

If the device has an additional cryptographic processor or controller in the device, then further security mechanisms are possible:

Cryptographic keys are not loaded from the device into the LA, but are used directly in the device. For this the interface needs extensions to enable the use of the keys.

These and other aspects of the invention will be apparent from and elucidated with reference to the embodiment(s) described hereinafter.

In the following drawings

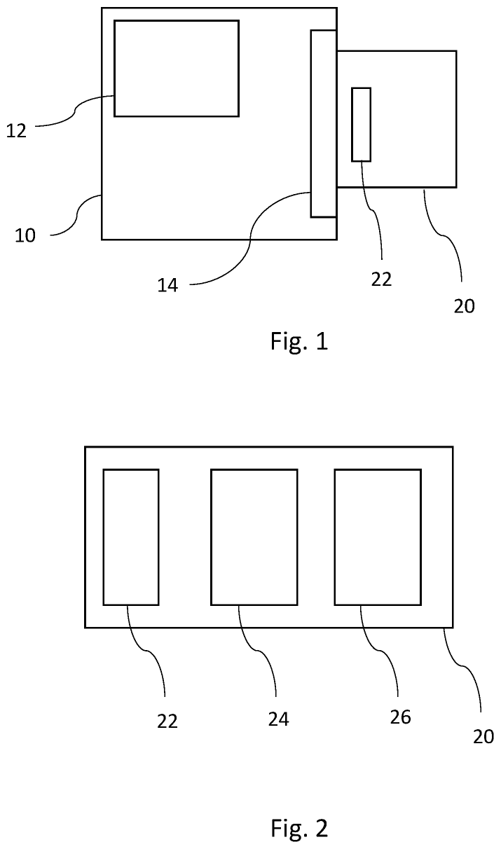

FIG. 1 shows an embodiment of a license agent apparatus and a device;

FIG. 2 shows a preferred embodiment of a device;

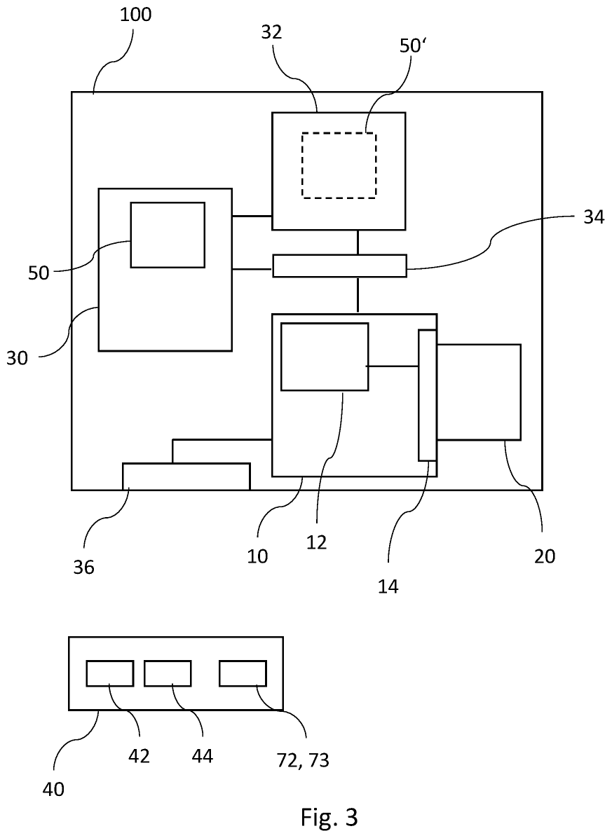

FIG. 3 shows a system according to the invention;

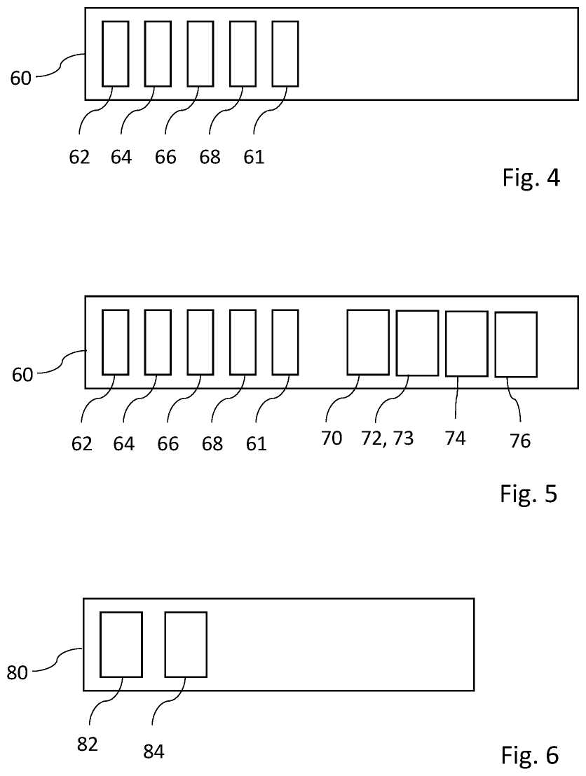

FIG. 4 shows an empty license container;

FIG. 5 shows a schematic view of a license container containing a license;

FIG. 6 shows a schematic view of an extension container;

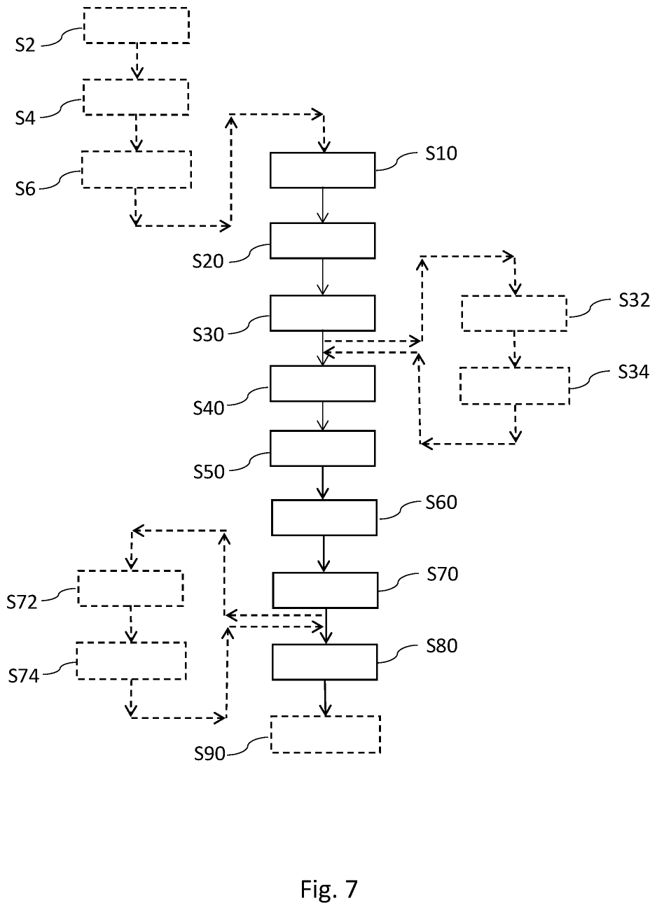

FIG. 7 shows a schematic flowchart of a method for creating an empty license container;

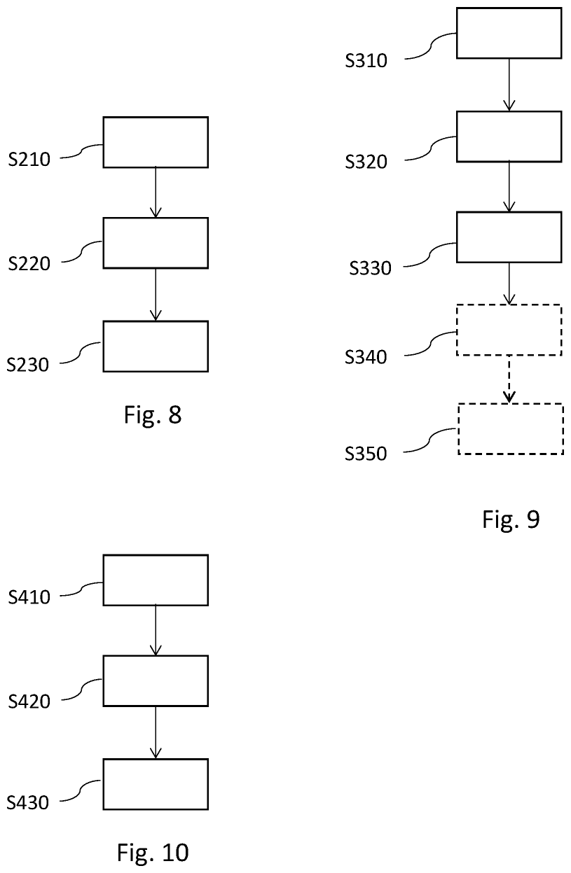

FIG. 8 shows a schematic flowchart of a method for restoring a private device key;

FIG. 9 shows a schematic flowchart of a method for handling a license container containing a license;

FIG. 10 shows a schematic flowchart of a method for filling an empty license container with license-relevant data;

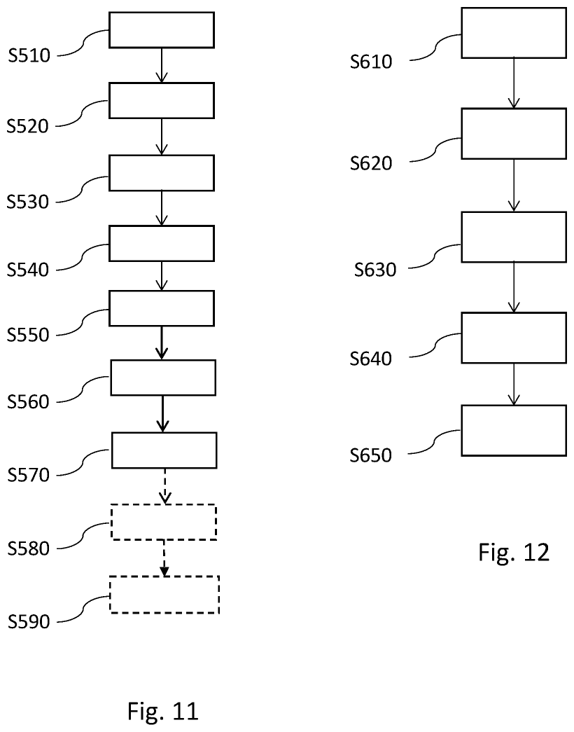

FIG. 11 shows a schematic flowchart for using a license contained in an encrypted license container; and

FIG. 12 shows a schematic flowchart of a method handling a counter value of a counter.

FIG. 1 shows a license agent apparatus 10 having a processing unit 12 and a device interface 14 to which a device 20 can be connected. The processing unit 12 is configured to create an empty license container which is able to accommodate a license for an application. In the processing unit 12, normally, the inventive method has been performed so that the empty license container is established. Therefore, the license agent apparatus or parts thereof can also be implemented as a software. The processing unit 12 as well as the device interface 14 can be part of another system, e.g. of a host computer or a machine or an industrial machine.

Via the device interface 14, the license agent apparatus 10 is capable of communicating with the device 20 and especially to request device-specific data to identify the device 20 uniquely.

As shown in FIG. 1, the device 20 need not contain any storage medium. It only has to contain device-specific data 22 based on which unique identity data for the device 20 can be created.

FIG. 2 shows a principle view of a device 20. In this embodiment the device 20 contains device-specific data 22, which may be a serial number, chip identification data, bad sector information, type of device, production data, production badge, or the like.

According to the embodiment shown, the device 20 also contains a storage medium 24, on which data can be stored. For example, the random number, which is used to generate a private device key, can be stored here.

In a preferred embodiment, the device 20 additionally contains a cryptographic processor 26, which is only accessible via a generic API or via a special communication protocol, which may be device-specific.

FIG. 3 shows an embodiment of an inventive system 100, such as a host computer. This system 100 comprises the license agent apparatus 10 with its processing unit 12 and the device interface 14. The system 100 further comprises a storage medium 30, on which an application 50 is stored, a processing unit 32 and an application interface 34 for communicating between the license agent apparatus 10 and the processor unit 32. To execute the application, it is loaded in the processor unit 32. The application running or being executed in the processor unit 32 is referred to as application 50′. The application 50′ may request a valid license 73 from the license agent apparatus 10 prior to launch.

According to the invention, the system 100 also includes a bi-directional interface 36 for exchanging the license container between the license apparatus 10 and a licensor device 40, which is able to enter a license into the license container. In an optional embodiment, the bi-directional interface 36 can be comprised in the license agent apparatus 10.

The licensor device 40 or licensor is in possession of a cryptographic key pair comprising a public licensor key, pub-L-key 42 and a private licensor key, priv-L-key 44. The licensor device 40 further is in possession of a license 73 or a license key 72 for licensor-issued applications.

FIG. 4 shows a principle view of a license container 60, which in this case is “empty”. This means, that the license container 60 does not contain a license 73 for an application 50.

As shown in FIG. 4, the license container 60, which has been created by the license agent apparatus 10, comprises unique identity data of the device 20, namely a D-UID 62, and unique identification data of a license, or an L-UID 64, as well as a link value 66, which contains information regarding a license 73, which has to be filled in the license container 60. The license container 60 further comprises a pub-D-key 68, which is the public key of the cryptographic key pair of the device 20. Optionally, the license container may also contain a D-UID-Cert 61, which is a self-signed certificate signed with the cryptographic key of the device 20 and which links the D-UID 62 with the public key pub-D-key 68.

While FIG. 4 shows an empty license container 60, license container 60 filled with a license 73 is shown in FIG. 5. Any of the above-mentioned parameters (61 to 68) may optionally also be included in the license container. However, at least part of the data can preferably be erased. The “filled” license container 60 contains license parameters 70, license key 72, optional license specification 74 and also optional limit values 76, e.g., a restricted amount of executions to be done with the license 73.

While the empty license container 60 according to FIG. 4 is signed by the license agent apparatus 10 with the private device key, it is also encrypted using the public licensor key, pub-L-key 42, so that only the licensor can decrypt the empty license container 60 with its priv-L-key 44. The “filled” license container, which contains the license 73, is later signed by the private licensor key, priv-L-key 44 and encrypted using the public device key, pub-D-key 68.

FIG. 6 shows a schematic view of a (linked) extension container 80, which is used to enhance the security of the license 73 and to restrict an unauthorized use of the application 50. The extension container 80 contains e.g., counter-values 82, which indicates the current and actual number of executions of an application using the license. The extension container 80 may also comprise backup values 84, so that a license 73 can be recreated in case of an erroneous update of the application or of the license container 60.

FIG. 7 shows a schematic flowchart of the method for creating an empty license container 60, which is performed by the license agent apparatus 10. In a step S10 specific data of the device connected via a device interface is determined. A further step S20 comprises generating randomly device-unique identity data based on the determined specific data 22 of the device 20 using a globally unique identifier. This identifier can be an alphanumeric string. Step S30 contains utilizing an L-UID 64 as unique identity data of the licensor of the application 50 to be licensed. In a step S40, a private device key, priv-D-key 78, of the device 20 is determined. The generation of the priv-D-key 78 is based on the specific data 22 of the device 20, on D-RND 79, which is a random number, and on the L-UID 64. Storing the L-UID 64 and the D-RND 79, preferably on the device 20, is done in a step S50. This data is later needed to regenerate the priv-D-key 78 for decrypting the license container 60 accommodating the license.

In a step S60, a license container 60 is created that includes at least D-UID 62, L-UID 64, and link value 66. In step 70, the license container 60 is encrypted with the public licensor key 42 so that the licensor or the licensor device 40 can decrypt the empty license container to enter the license 73 or license key 72 for a licensed application. According to a further step S80, the created license container 60 is encrypted using a public licensor key, pub-L-key 42. In a further step S90 the encrypted license container 60 is optionally provided. For example, the license container 60 can be sent via the internet, via a storage medium such as a memory stick or a memory card, or via another wireless or wired connection to the licensor 40, so that the licensor 40 can store a license in the container.

In a preferred embodiment of the described method before performing step S10 optional steps are performed to establish a communication between the license agent apparatus 10 and the device 20. In a step S2 the device 20 connected to the device interface 14 is identified. In a further step S4 loading a communication protocol corresponding to the identified device 20 is performed, and in a further step S8 the communication protocol is used for communication and data exchange with the device 20. Preferably, a generic API is used.

In a further preferred embodiment of the method an additional step S72 is performed, comprising signing the license container 60 with the priv-D-key 78 of the device 20. In a further optional step S74 the pub-D-key 68 is stored in the license container 60. This step is performed before the license container 60 is encrypted using the public licensor key 42.

In a further optional and preferred embodiment of the method an optional step S32 comprises creating a self-signed D-UID-cert 61 using the priv-D-key 78 and the D-UID 62, so that the D-UID 62 is bound to the pub-D-key 68 of the device 20. A further optional step S34 comprises storing the D-UID-Cert 61 in the license container 60.

FIG. 8 shows a schematic flowchart of a method for restoring a private device key. A step S210 retrieving the device-specific data 22 from the device 20 is performed. Preferably, the device 20 is connected via the device interface 14 so that the license agent apparatus 10 can access the device 20. This method is also performed by the license agent. In a further step S220 the D-RND 79, preferably stored on the device 20, and the L-UID 64, preferably stored on the device 20, are retrieved. In a further step S230 using this information the private D-key 78 of the device 20 is restored. This key is used to decrypt the license container 60 to use the contained information, preferably the contained license or license key 72 to execute an application 50.

FIG. 9 shows a method for handling a license container 60 containing a license. This method is preferably performed by the license agent. After receiving a request for a license from the application 50′ executed in the processor unit 32 of the system 100, the license agent receives in a step S310 a license container 60 containing a license for the application 50. In a step S320 the license container 60 is decrypted using the priv-D-key 78 of the device 20. In a further optional step S330, the license container 60 is verified, preferably using the public licensor key 42, which is publicly accessible. The verification of the license container 60 may preferably be performed mathematically and/or in terms of its contents.

In an optional step S340 the encrypted license container 60 may be stored on the device for later use with the application 50. However, in a preferred embodiment, the encrypted license container 60 is not stored and only the information that the valid license 73 is contained in the license container 60 is transmitted from the license agent to the executed application 50′, which runs in the processor unit 32 of the system 100.

An optional step S350 is directed to allowing the application 50 to use the license contained in the license container 60 after decrypting the license container.

FIG. 10 shows a flowchart for a method for filling an empty license container 60 bound to a device 20 with license-relevant data. This method is normally performed on the licensor's side. In a step S410 decrypting the empty license container 60 using the private licensor key 44 is performed. This step takes place after the licensor 40 has received the license container 60 from the license agent apparatus 10.

In a further step S420, the license container 60 is filled with at least one of several data of the group comprising at least the D-UID 62 of the device 20 to which the license should be bound, a D-UID-cert 61, a link value 66 based on the application 50 to be licensed, a license parameter 70, a license specification 74, a license key 72 of the application 50, and optionally limit values, e.g. regarding a counter contained in the device in a cryptographic controller 26. In a further step S430, the filled license container 60 is encrypted with the pub-D-key 78 of the device so that the license agent apparatus can later decrypt the license container as described above. The license container may be additionally signed by the licensor device 40 with the priv-L-key 44.

FIG. 11 shows a method for using a license 73 or license key 72 contained in an encrypted license container 60 for an application 50. In a step S510, a request for a license or a license key 72 is received by the license agent from the application 50 or 50′. In a further step S520, the license container 60 containing the license 73 is determined. In a step S530 creating a priv-D-key 78 of the device 20 to which the license container 60 is bound, is performed by retrieving device-specific data 22 from the device 20, by retrieving an L-UID 64 and a D-RND 79, which is a random number stored on the device 20.

A further step S560 comprises decrypting the license container 60 using the recreated priv-D-key 78 of the device 20. In a step S550 the license container 60 is verified using the public licensor key 42, wherein the verification is done mathematically and/or in terms of contents. In a step S560 use of the license 73 is allowed for the application which requests the license use. A further step S570 comprises providing the license key 72 or the license which is contained in the license container 60. The license key 72 is provided to the application 50 so that it can be executed. Alternatively, the license agent sends a confirmation command to the application 50 or to the processor unit 32 executing the application, wherein the confirmation command may contain a signal indicating that a valid license is present.

In a preferred embodiment according to the invention, the device 20 comprises a counter 90, which may be contained in a cryptographic controller 26 of the device. In this case, a use counter value 92 is changed in a further step S580 when the license key is provided to the application 50. In a further step S590 the use counter value is checked against a start value or a limit value 76 which may be contained in the license container. Optionally, the changed use counter value can also be stored and updated in an extension container 80 so that the contained counter value 82 is changed.

FIG. 12 shows a schematic flowchart of a method handling a counter value of a counter 90. In case of a backup value of the current use counter value 92 of the counter 90 being stored in a extension container 80, further steps have to be performed. The extension container 80 is linked to the license container 60 and preferably encrypted with the pub-D-key 68 of the device 20. In a step S610 retrieving the current use counter value 92 from the counter 90 is performed. A step S620 comprises comparing the current use counter value 92 from the counter 90 with a backup value of the use counter value 92, which is the counter value 82. If the two values, 92 and 82, are equal, in a step S630 the use of the application secured by a license is allowed. In a further step S640, a change of the value of the current use counter value 92 in the counter 90 is performed. In a further step S650, the backup value, namely the counter value 82 in the extension container 80 is overwritten with the new current use counter value 92 for the current use.

The method steps disclosed according to the figures and described herein may be carried out in a sequence other than that indicated. Individual or multiple steps may be repeated singly or in groups, singly or multiple times, without departing from the methods disclosed in the claims.

Since the problem to be solved is in the area of usage control of an application, license or license parameter, a method for controlling a license parameter is proposed in which the license parameter is stored locally and read-only accessible on a target device (host computer platform) and in which at least usage state information associated with the license parameter is stored in a protected location of the removable device. The control of the usage state information is performed by the LA, preferably installed on the target computer, host computer, machine or system.

Another aspect of the invention and preferred and optional embodiments are described:

Two categories of license parameters may be proposed for the embodiment of the method, the core license parameters in a license container and the extended license parameters in an extension container. Both types of license parameters can be preferably imported together from the LA and can form the license.

The extended license parameters are preferably cryptographically linked to the core license parameters in the license container to add extended parameters to the core license data. Data may have extended parameter data representing functions and properties of a license. The extended license parameters may be modified by the LA based on the use of a license on a target device and according to the functions and features allowed during the lifetime of a license.

In order to increase the trustworthiness of the functions of the so-called authorization management system, the LA may be authorized, as part of the system, to save one or more sensitive data of the extended license parameters to a protected location of the device or other apparatus. The LA shall be able to store the sensitive values on the device and retrieve them via the generic API under specific access conditions determined by the LA in communication with the device.

In another preferred embodiment of the invention, the access conditions are provided by a specific manufacturer of the device. The access conditions and methods for accessing a protected memory location may be defined by memory access standards or by optional and proprietary functions provided by the manufacturer that the LA may and/or may not use via the generic API. The methods and functions may include that the LA uses the following:
1. a password-protected storage area in a preferably self-encrypting device, where the password can be set once or assigned by or to the licensor, optionally making the password available to the LA through license parameters
2. the right to create a private partition on the device
3. a storage area within a cryptographic controller with allocated and/or access-protected address spaces that can be accessed, requiring an authentication protocol for mutual authentication between the device and the LA
4. other similar methods for conditional access.

An alternative, also preferred, embodiment of the concept of the security architecture of the entitlement management system that provides the types of license parameters against the specific storage capacities of a device used for entitlement protection may be described by the following steps:
A: The licensor generates the core and extended license parameters according to the license specification.
   1. core license parameters are read-only parameters with respect to the LA and cannot be modified by the LA. The licensor encrypts the parameters with the key belonging to the device (D-UID-key) and signs them with the licensor key (L-UID-key). A counter value or an expiration date are examples of a core license parameter.
   2. extended license parameters are read/write parameters and can be modified by the LA, and the licensor protects them with the device keys using the D-UID-key pair for authentication and decryption.
   3. the core and extended license parameters may be stored in the license container with the respective UID.
B: Initial activation of a license at the licensee

The LA starts processing the license container:
1. the LA imports the license container
2. according to the rules of the Entitlement Management System, the LA identifies a core license parameter value to be stored on a protected storage location of the device, e.g., the parameter specifying the maximum number of times an app can be used.
3. the LA conditionally accesses the device via the generic API using one of the methods to address a protected storage location.
4. a write command is used to store the value on the protected location, e.g., in a monotonically decrementing counter.
5. with the value saved on the device, the consumption of the license is triggered and enforced by the LA.
6. the LA imports the extended license parameter and signs it with D-UID-key.

Every time there is a closure of the consumption of the license, the extended license parameter is updated in the extension container file and the updated file can be saved either on the device or on any other storage area or on the system itself. Thus, the count value of the monotonic counter remains synchronized identically with the count value obtained in the extended license parameter.
C: A license continues to run on another host computer platform and license tracking is enforced by a monotonic counter.

Preferably, in the event that, after a license is consumed, the device is deployed to another host computer where the same conditions exist—the LA and the same licensed application or software or machine program as on the previous host computer or machinery—the LA and generic API (D-Comm) must be activated when the device is present to verify that a valid license is tied to a device. Preferably or optionally:
1. the LA identifies the type of device used.
2. further identifies a generic API driver (D-Comm) that fits to support communication with the device type and, if necessary, loads the generic API driver (D-Comm) to communicate and retrieve the device specific data.
3. the LA retrieves the device specific data and reads the D-UID, reads the D-RND, and the L-UID and create the device key pair, especially to derive the private (device) D-UID-key, priv-D-key, again and to decrypt the license container, the license and the D-UID.
4. the LA checks that the D-UID of the license container matches the D-UID-cert of the license container and releases the license for further processing.
5. the LA conditionally reads the counter value from the monotonic counter. Since the LA infers (“knows”) from the comparison of the monotonic counter value with the value read from the core parameter as the limiting usage value, that the counter value has been changed either by incrementing or decrementing in monotonic steps.
6. the LA reads the value of the extended license parameter.
7. the LA compares the value of the extended license parameter with the monotonic counter value, if they are equal, it continues processing.
8. the LA compares the counter values with the marginal usage value of the core license parameter and decides whether to allow or block further execution of the license.
9. if further execution is allowed, LA updates monotonic counter and sets identical counter value in the extended license parameter.
10. LA signs extended license parameter with D-UID-key.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the description is intended to be illustrative, but not limiting the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such software may also be distributed in other forms, such as via the Internet or other wired or wireless telecommunication systems. A method according to the present invention may particularly be carried out to control the operation of a software defined radio.

The elements of the disclosed devices, host computers, machines, and systems may be implemented using appropriate hardware and/or software elements, e.g., appropriate circuitry. A host computer may include central processing units, graphics units, and microprocessors programmed or configured using software code.

1-30. (canceled)

31. License agent apparatus for handling a license of an application of a licensor, comprising
a device interface to communicate with a device having specific data;
a processing unit to generate a license container configured to maintain a license for the application;
the processing unit being configured to:
determine specific data of the device connected via the device interface;
generate a globally unique identifier, so-called device unique identity data, D-UID, based on the specific data of the device and optionally random data;
utilize an L-UID as unique identity data of the licensor of the application to be licensed;
create a license container containing at least the D-UID, the L-UID and a link value based on the application to be licensed;
encrypt the license container using a public licensor key, pub-L-key;
optionally provide the license container.

32. License agent apparatus according to claim 31 wherein the processing unit is further configured to identify the device connected to the device interface and to load a communication protocol corresponding to the identified device and to use the communication protocol for communication and data exchange with the device.

33. License agent apparatus according to claim 31, wherein the processing unit is further configured to
determine a private device key, priv-D-key of the device based on the specific data of the device, on a D-RND random number, and optionally on the L-UID;
optionally store the L-UID and/or the D-RND for later use; and
create the public device key, pub-D-key based on the private device key, priv-D-key.

34. License agent apparatus according to claim 33, wherein the processing unit is further configured to sign the license container with the priv-D-key and to store the pub-D-key in the license container before encrypting using the public licensor key (pub-L-key).

35. License agent apparatus according to claim 34, wherein the processing unit is further configured to create a self-signed D-UID-certificate, D-UID-cert, using the priv-D-key, the pub-D-key and the D-UID, and to store the D-UID-cert in the license container.

36. License agent apparatus according to claim 31, wherein the processing unit is further configured to retrieve the device specific data from the device connected via the device interface, the D-RND, and the L-UID, and to restore the priv-D-key to decrypt the license container to use the contained information.

37. License agent apparatus according to claim 31, wherein the processing unit is further configured to receive a license container containing a license for the application, and to store the license container on the device connected to the device interface.

38. License agent apparatus according to claim 36, wherein the processing unit is further configured to allow the application to use the license contained in the license container after decrypting the license container.

39. License agent apparatus according to claim 31, wherein the processing unit is further configured to receive a license container containing a license for the application, to verify the license container.

40. Device having specific data characterizing the device and being configured to be bound to a license container, which is suitable to contain at least a license for an application, and being configured to communicate with a license agent or a license agent apparatus to provide the specific data for identifying the device and for creating a device unique identity data, D-UID.

41. Device according to claim 40, wherein the device is configured to store data and to comprise a storage medium and is configured to store a license container; wherein the specific data of the device comprise at least one member selected from the group comprising at least serial number, chip identification data, bad sector information, type of device, production data, production batch, safety information stored in the device.

42. Device according to claim 40, wherein the communication with the device takes place using a generic API.

43. Device according to claim 40, wherein the device comprises a password protected storage area in a self-encrypting region of the device and/or a cryptographic controller having a storage capacity, wherein the license container and/or the D-RND and/or the L-UID is stored in the password protected storage area or in the storage capacity of the controller.

44. Device according to claim 40, wherein the device contains a non-resettable counter, wherein the counter can be decreased from a start value to zero or can be increased from zero to a limit value, wherein the start value and/or the limit value are contained in the license container and are unchangeable.

45. Device according to claim 44, wherein the device comprises a restricted area with restricted access, wherein the counter is located in the restricted area and wherein the restricted area is only accessible using the priv-D-key.

46. Licensor device comprising a processor unit being configured to receive a license container; decrypt the license container using the private licensor key; fill the license container with at least one data of the group comprising at least a D-UID, a link value based on the application to be licensed, license parameters, and license keys of the application; encrypt the filled license container with the public device key.

47. System for handling a license of an application of a licensor, the license being contained in a license container and being bound to a device, comprising a device having specific data characterizing the device and being linked to the license in the license container and being configured to provide the specific data for identifying the device;
a license agent apparatus configured to handle a license container containing the license to execute the application, and to communicate with the device so that device specific data can be read out from the device;
wherein the binding between the license in the license container and the device is based on the specific data, so that the application can only be executed if the license is valid and the device is present.

48. System according to claim 47, wherein the system further comprises
a storage medium on which the application is stored;
a processor unit for executing the application;
an application interface for communicating between the license agent apparatus and the processor unit for executing the application requiring a license to be executed;
a bidirectional interface to exchange at least the license container between the license agent apparatus and a licensor device, the licensor device being configured to enter a license in a license container;
wherein
the license agent apparatus is further configured to communicate with the application requiring the license, optionally to communicate with the device to exchange data with the device for storing data in the device, to communicate with the licensor at least for receiving the license container filled with the license created by the licensor.

49. License container containing at least one data of the group comprising a D-UID, a D-UID-cert, a link value based on the application to be licensed, license parameters, license specifications, and a license key for executing the application, wherein the license container is encrypted with the public licensor key and/or with the pub-D-key.

50. Extension container being linked to the license container according to claim 49, being configured to be accessible using the priv-D-key and comprising a current value of a counter which is stored in the device.

51. Method for creating an empty license container bound to a device connected and prepared for housing a license for an application, comprising the following steps:
determining specific data of the device connected via a device interface;
generating a globally unique identifier, so-called device unique identity data, D-UID, based on the specific data of the device and optionally random data;
utilizing an L-UID as unique identity data of the licensor of the application to be licensed;
determining a private device key, priv-D-key of the device based on the specific data of the device, on a D-RND random number, and optionally on the L-UID;
optionally storing the L-UID and/or the D-RND on the device for later use;
creating the public device key based on the priv-D-key;
creating a license container containing at least the D-UID, the L-UID and a link value based on the application to be licensed;
encrypting the license container using a public licensor key, pub-L-key; and
optionally providing the encrypted license container.

52. Method according to claim 51, further comprising the following steps:
identifying the device connected to the device interface;
loading a communication protocol corresponding to the identified device, and
using the communication protocol for communication and data exchange with the device,
wherein a generic API is used.

53. Method according to claim 51, further comprising the following steps:
signing the license container with the priv-D-key, and
storing the pub-D-key in the license container before encrypting using the pub-L-key.

54. Method according to claim 51, further comprising the following steps:
creating a self-signed D-UID-cert using the priv-D-key and the D-UID to bind the D-UID to the pub-D-key, and
storing the D-UID-cert in the license container.

55. Method according to claim 51, further comprising the following steps:
retrieving the device-specific data from the device,
retrieving the D-RND stored on the device and the L-UID stored on the device, and
restoring the priv-D-key to decrypt the license container to use the contained information.

56. Method for handling a license container containing a license, comprising the following steps:
receiving a license container containing a license for the application,
decrypting the license container using the priv-D-key,
optionally verifying the license container,
storing the encrypted license container on the device for later use with the application, and
optionally allowing the application to use the license contained in the license container after decrypting the license container.

57. Method for filling an empty license container bound to a device with license relevant data, comprising the following steps:
decrypting the empty license container using the priv-L-key;
filling the license container with at least one data of the group comprising at least a D-UID of the device to which the license should be bound, a D-UID-cert, a link value based on the application to be licensed, a license parameter, license specifications, and a license key of the application;
encrypting the filled license container with the pub-D-key;
wherein the D-UID is based on specific data of the device, on a D-RND, and on a unique identity data set, L-UID identifying the licensor.

58. Method for using a license contained in an encrypted license container for an application, comprising the following steps:
receiving a request for a license by an application;
determining a license container containing the license for the application;
recreating a priv-D-key of a device to which the license container is bound by retrieving device-specific data from the device, retrieving an L-UID being unique data of the licensor of the license, retrieving a D-RND stored on the device;
decrypting the license container using the priv-D-key of the device;
verifying the license container using the pub-L-key;
allowing the use of the license for the application requested the license use;
providing a license key contained in the license container to the application.

59. Method according to claim 58, wherein, if the device to which the license is bound comprises a counter, a use counter value of the counter is changed by using the application and the use counter value is checked against a start value and/or a limit value of the license usage which is stored in the license container and/or may be stored additionally in a restricted area of the device.

60. Method according to claim 59, wherein a backup value of the current use counter value of the counter is stored in an extension container, which is linked to the license container and encrypted with the pub-D-key, comprising the following steps:
retrieving the current use counter value of the counter from the counter;
comparing the current use counter value from the counter with the backup value of the current use counter value;
if both values are equal, allowing use of the application secured by the license; and
changing the value of the current use counter value in the counter; and
overriding the backup value in the extension container with the new current use counter value.
